(19) United States
(12) Patent Application Publication
(10) Pub. No.: US 2004/0120289 A1
(43) Pub. Date: Jun. 24, 2004

(54) Transmission of information in a wireless communication system

(76) Inventors: Jyri K. Hamalainen, Oulu (FI); Risto Wichman, Helsinki (FI); Esa Tiirola, Oulu (FI)

Correspondence Address: SQUARE, SANDERS & DEMPSEY LLP, 14TH Floor, 8000 Towers Crescent Drive, Tysons Corner, VA, 22182-2700, US

(21) Appl. No.: 10/324,088

(22) Filed: Dec. 20, 2002

(51) Int. Cl. H04B 7/216

(52) U.S. Cl. 370/335; 370/342

(57) ABSTRACT

The present invention relates to a method in a communication system that is adapted to provide communication channels for transmission of information to user equipment in time frames such that information to a plurality user equipment can be multiplexed into a time frame. The method comprises receiving signals from transmitting elements of the communication system in at least two user equipment, processing the received signals at said at least two user equipment to generate respective feedback signals, receiving the feedback signals at a controller associated with the transmitting elements of the communication system, and processing the feedback signals at the controller for determining how to multiplex information into time frames in further transmissions to said at least two user equipment. The determination is based on the feedback signals and a resource allocation scheme that allows use of same resource for transmissions to the at least two user equipment if a predefined condition is met. A communication system and a controller for use in a communication system is also disclosed.

### FIELD OF THE INVENTION

The present invention relates to wireless communication systems, and in particular to transmission of information on wireless channels to a plurality of user equipment. The herein described solution may be used e.g. in a communication system serving mobile user equipment wherein information is communicated from a plurality of antennae on wireless communication channels that are distinguished from each other by means of appropriate orthogonal resources. The orthogonal resources may comprise resources such as time resources, code resources and/or frequency resources.

### BACKGROUND OF THE INVENTION

A wireless communication system is a facility that enables communication via a wireless interface between two or more station entities such as base stations, user equipment and/or other transmitting and/or receiving nodes of the system. The stations entities are typically provided with antenna means of some kind for enabling the transmission and/or reception of signals. The communication may comprise, for example, communication of voice, data, multimedia and so on.

An example of the wireless communication systems is a public land mobile network (PLMN). A PLMN is typically a cellular network. In a cellular network the area covered by the network is divided into a plurality of cells. Each cell is served by a base station which transmits signals in the downlink (DL) direction to and receives signals in the uplink (UL) direction from mobile user equipment i.e. mobile stations in the associated cell. These mobile user equipment can be mobile telephones or any other type of mobile stations such as a portable computer with wireless communication capabilities. The operation of the base station apparatus and other elements of the network enabling the communication can be controlled by one or several control entities. The various control entities may be interconnected.

Several different cellular systems are known. These are typically standardised such that the various elements of the particular system may operate within the system. The communication between mobile user equipment and base stations is thus typically based on appropriate communication protocols and standards. The standards define, among other things, features on that are to be used by the system such as the frequency range, access technique, multiplexing technique and so.

An example of the access techniques used by the cellular systems is the code division multiple access (CDMA). The CDMA a direct sequence spread spectrum technique. The use of (CDMA) or a wideband CDMA (WCDMA) is being proposed for the next generation of cellular telecommunication networks (the so called third generation (3G) standards). Code division multiple access is also employed e.g. in the IS-95 and CDMA 2000 standards. Another examples of access techniques include time division multiple access (TDMA), space division multiple access (SDMA), and orthogonal frequency division multiple access (OFDMA).

With the CDMA technique the base stations and mobile stations may transmit signals over all of the available frequency range. The mobile user equipment in one cell associated with a first base station may also use the same frequency as mobile user equipment in an adjacent cell associated with a second base station. A mobile user equipment or a base station will therefore receive a relatively large number of signals in the used frequency range. The different mobile user equipment can be distinguished by the respective base stations as each mobile station will be using a different spreading code for the communication. In order to isolate a particular signal at the receiving end, the signals are despread after reception thereof. That is, in order to distinguish the signals, different and typically orthogonal spreading codes are applied thereto and in reception the desired signal is isolated from other signals based on information of the spreading code. The undesired signals will in a typical case provide interference.

The capacity of a CDMA system depends, among other factors, on the level of the interference to a desired signal. If the signal to interference ratio (SIR) of the connection does not meet a certain threshold value the quality of the service may become reduced and/or a connection relying on the desired signal may not be established at all or may be dropped. A wireless communication system such as the CDMA is thus inherently interference limited. Interference may severely affect the performance of the system, both in the terms of capacity and coverage. Forms of interference include, without limiting to these, multiple access interference from other users in the system (either in the same or different cells) and adjacent channel interference (ACI) such as interference from other WCDMA FDD (frequency division duplex) and TDD (time division duplex) carriers. Other types of interference may also be present.

Mobile communication services have become very popular among various types of users. Thus the number of mobile user equipment has increased radically during the last few years. In addition to the conventional communication of voice (e.g. telephone calls), various data communication applications are also becoming increasingly popular.

The increase in the number of user equipment subscribing to a communication system and introduction of new type of services has led to capacity and interference problems. These may occur especially during the so-called peak times. Furthermore, growing public demand for high data rate services, such as multimedia services, means that the link capacity provided by conventional cellular communication networks may not always be sufficient for all applications.

The orthogonal code space is regarded as being one of the critical resources of communication systems that are based on the Code Division Multiple Access (WCDMA). This is especially believed to be the case in the WCDMA downlink (DL) transmissions. A reason for this is that e.g. in the so called High Speed Downlink Shared Channel (HS-DSCH) transmissions multiple codes of spreading factor (SF)=16 can only be used within a downlink transmission subframe. In other words, the standard defines that only codes with SF=16 can be used in a High Speed Downlink Packet Access (HSDPA) transmission. Although such codes may provide a relatively high data rate (the data rate increases when the SF is gets smaller), the SF=16 restricts heavily the number of possible users. In maximum there can be 16 users. However, some branches of the code tree may need to be reserved for control purposes.

Resulting from various reasons such as system load and too large number of users, the capacity of the HS-DSCH might thus be limited due to a shortage of available orthogonal spreading codes.

Higher coding rates and higher order modulation schemes may be used to partially resolve the problem. However, these solutions are not believed to provide a satisfactory solution to the problem of shortage of available orthogonal codes. A reason for this is that when the coding rate is decreased (e.g. from ⅓ to ½) the data rate per code channel is increased. Although this alleviates the code limitation problem, the link performance is degraded due to the decreased amount of coding gain. For that reason, more transmission power is needed to maintain the same quality of service (QoS). This generates more interference to the other users. Higher coding rates will thus eventually lead to code shortage problem and use of higher order modulation schemes is thus limited since they work only if signal interference ratio (SIR) for a certain user is high enough. This requires more transmission power which in turn causes more interference.

Another proposal is to use the same spreading code for transmissions to two user equipment. This scenario employs antenna selection such that a user having a strong channel from antenna A and a weak channel from antenna B is scheduled to antenna B and, at the same time, another user having a strong channel from antenna B and a weak channel from antenna A is scheduled to antenna B where after a spreading code can be used for the two users. This is assumed to be possible because it is believed that the scheduling before transmissions ensures a substantially low cross channel interference to be experienced by the two users. However, the proposal is not fully compatible with the present communication standards, and would probably require changes to the standards and in any case is believed by the inventors to be difficult to implement within the present standards. Furthermore, the proposal is only applicable for codes that are set aside for High Speed Downlink Packet Access (HSDPA).

Use of a special secondary scrambling code has been proposed in order to obtain full reuse of the spreading codes for a time frame. Introduction of an additional (secondary) scrambling code would be used to avoid above discussed problem in the number of users in the HSDPA applications, as a new set of SF=16 codes could be used. However, a problem is that this would lead to increase in the interference. Introduction of secondary scrambling codes would also cause more interference in a cell and therefore additional power would be needed for the primary scrambling code user to maintain performance. Furthermore, this proposal would require changes to the present communication standards. The required changes might be difficult to agree and/or implement. In addition to the changes in the system standards, the introduction of antenna selection scheme would also require changes to the present mobile user equipment. For example, new channel estimation and SIR estimation algorithms and means for execution thereof would be needed at the user equipment.

Thus the inventors believe that the above proposals for code reuse may not be the right solution for addressing the capacity problems caused by limited amount of orthogonal resources such as spreading codes.

### SUMMARY OF THE INVENTION

Embodiments of the present invention aim to address one or several of the above problems.

According to one aspect of the present invention, there is provided a method in a communication system, the communication system being adapted to provide communication channels for transmission of information to user equipment in time frames such that information to a plurality user equipment can be multiplexed into a time frame. The method comprises receiving signals from transmitting elements of the communication system in at least two user equipment, processing the received signals at said at least two user equipment to generate respective feedback signals, receiving the feedback signals at a controller associated with the transmitting elements of the communication system, and processing the feedback signals at the controller for determining how to multiplex information into time frames in further transmissions to said at least two user equipment. The determination is based on the feedback signals and a resource allocation scheme that allows use of same resource for transmissions to the at least two user equipment if a predefined condition is met.

According to another aspect of the present invention there is provided a communication system comprising a plurality of user equipment, each user equipment comprising a transceiver and a processor, transmitting elements arranged to provide communication channels for transmission of information to the plurality of user equipment in time frames such that information can be multiplexed into a time frame, and a controller associated with the transmitting elements. The arrangement is such that the processor of each user equipment is arranged to process signals received by the transceiver from the transmitting elements to generate a feedback signal, and the feedback signals is processed at the controller for determining how to multiplex information into time frames in further transmissions to user equipment based on the feedback signals and a resource allocation scheme that allows use of same resource for transmissions to at least two user equipment if a predefined condition is met, and the transmitting elements are arranged to use said same resource in a time frame for transmission to the at least two user equipment if so decided by the controller.

According to another aspect of the present invention there is provided a controller for use in association with transmitting elements of a communication system. The transmitting elements are arranged to provide communication channels for transmission of information to a plurality of user equipment in time frames such that information can be multiplexed into a time frame. The controller is arranged to process feedback signals from the user equipment for determining how to multiplex information into time frames in further transmissions to user equipment based on the feedback signals and a resource allocation scheme that allows use of same resource for transmissions to at least two user equipment if a predefined condition is met. The controller then controls the transmitting elements to use said same resource in a time frame for transmission to the at least two user equipment.

In more specific form of the invention, the resource comprises a spreading code of a code division multiple access system. The code division multiple access system may comprise a wideband code division multiple access system or a code division multiple access 2000 (CDMA 2000) system. Transmission of information may be implemented by means of frequency division duplexing. High speed downlink packet access may also be used.

Transmission of information may also occur by means of orthogonal frequency division multiple access. In such case the shared resource comprises a subfrequency.

The condition may be considered as being is met in response to detection that the feedback signals from two mobile stations are complimentary.

Antenna weights of the transmitting elements may be adjusted so that the predefined condition can be met.

The feedback may be sent in accordance with wideband code division multiple access frequency division duplex (WCDMA FDD) mode 1 or mode 2.

The embodiments of the invention may provide a simple and effective manner to address shortage of available channel resources such as spreading codes. The proposed embodiment can be implemented without any significant changes to the existing communication standards or proposals for standards and/or hardware. It is expected that the embodiments improve performance of the existing communication systems.

### BRIEF DESCRIPTION OF DRAWINGS

For better understanding of the present invention, reference will now be made by way of example to the accompanying drawings in which:

FIG. 1 shows an environment wherein the present invention may be embodied; and

FIG. 2 is a flowchart illustrating the operation of one embodiment of the present invention.

### DESCRIPTION OF PREFERRED EMBODIMENTS OF THE INVENTION

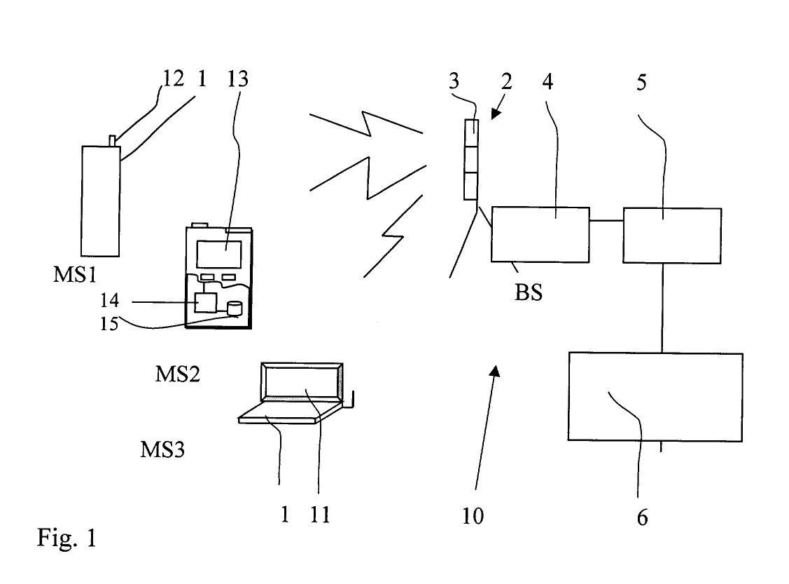

Before explaining the preferred embodiments of the invention in more detail, a reference is made to FIG. 1 which is a simplified presentation of a communication system in which the embodiments of the invention may be employed. More particularly, FIG. 1 shows a mobile communication network 10 providing wireless communication services for a plurality of mobile user equipment 1 by means of a base station 2. The user equipment 1 will be referenced to in the following as mobile stations MS1 to MS3.

The mobile stations may consists of different type of mobile user equipment. A mobile station is typically provided with a transceiver for wirelessly receiving and transmitting signals from and to base stations of the mobile communication network. In FIG. 1 the transceiver is denoted by an antenna 12. The operation of a mobile station 1 may be controlled by means an appropriate user interface such as control buttons 13, a touch screen, voice activation means and so on. A display 11 may also be provided for displaying images and other visual information for the user of the mobile station 1. The mobile stations are also typically provided with processors 14 and a memory means 15 for enabling the cooperation thereof with the network apparatus. The mobile stations 1 are also typically provided with speaker and microphone means for enabling voice communication by the user thereof (not shown for clarity).

The skilled person is familiar with the features and operation of a typical mobile station. Thus these do not need any further explanation. It is sufficient to note that the user may use the mobile user equipment 1 for task such as for making and receiving phone calls, for communication of data with the network and so on. A mobile station is typically enabled to move within the base station coverage area and also from one base station coverage area to another coverage area. The location of the mobile station may thus vary in time as the mobile station is free to move from one location (base station coverage area or cell coverage area) to another location (to another coverage area) and also within one coverage area.

The base station 2 is provided with an antenna array 3 consisting of a multiple antenna elements for transmission and reception of information signals. Each of the mobile stations MS1 to MS3 is shown to be in wireless communication with the transmitting elements 3 of the base station 2.

A base station is also typically provided with a controller function for controlling the operation thereof. The implementation of this controller function depends on the standard applied for the base station. The following will use the term base station controller when a reference is made to a controller function for controlling the transmitting elements 3 of the base station 2. The operation of the transmitting elements 3 of the base station 2 may be controlled by a controller function provided by means of an integrated base station controller or a controller entity that is provided as a separate entity from the base station. This is an implementation issue and does not affect the basic operational principles of the present invention.

It shall be appreciated that in some systems, such as in the systems providing 3^{rd} generation telecommunication services, the base station may be referred to as Node B. For clarity reasons this specification will use the term base stations for all kinds of stations that are capable of transmitting signals towards and/or receiving signals from mobile stations.

It shall also be appreciated that although FIG. 1 shows only three mobile stations MS1 to MS3 and one base station 2, a substantial number of mobile stations MS1 to MSn may be in simultaneous communication with the mobile communication network 10. Furthermore, a plurality of base stations is typically provided.

As the elements of a cellular mobile communication network as such do not form an essential element of the present invention, these are not described or shown in any more detail herein. It is sufficient to note that a mobile communication system operates in accordance with a given standard or specification which sets out what the various elements of the system are permitted to do and how that should be achieved. For example, the standard or specification may define if the user, or more precisely, user equipment such as a mobile station is provided with a circuit switched service and/or a packet switched service. Communication protocols and/or parameters which shall be used for the connection may also be defined. In other words, a specific set of “rules” on which the communication can be based on needs to be defined to enable communication by means of the system. Depending on the given standard, the mobile communication network may comprise various network elements 5 such as radio network controllers, mobile switching centres, other switches and/or exchanges, and so on. One or more gateway nodes 6 may also be provided for connecting the one network to other networks. The other networks may be based on different standards.

The below described embodiment relates to a scheduling scheme for code multiplexing wherein the mobile stations can be assigned the same resource such as a channelization code in a time frame. For example, a spreading code may be assigned to two mobile stations for example when the two mobile stations have requested in their feedback signals orthogonal signals from the base station. In such as case the transmit weights for said two mobile stations can be set to be are orthogonal, as will be explained in more detail below.

The scheduler can be implemented in the controller function controlling the transmitting elements 3. Schedulers as such are known, and any appropriate scheduler may be used for allocation of the resources in accordance with the principles of the present invention.

The below described more detailed embodiment relates to a base station for a UMTS Terrestrial Radio Access system wherein Frequency Division Duplex is employed (UTRA-FDD), and more particularly to the so called Medium Access Control High speed (MAC-HS) part of such access system. The embodiment employs the High Speed Downlink Packet Access (HSDPA) packet scheduling scheme for scheduling of the transmissions based on the feedback from the mobile stations. The HSDPA is a proposed future variation of the WCDMA for packet data traffic.

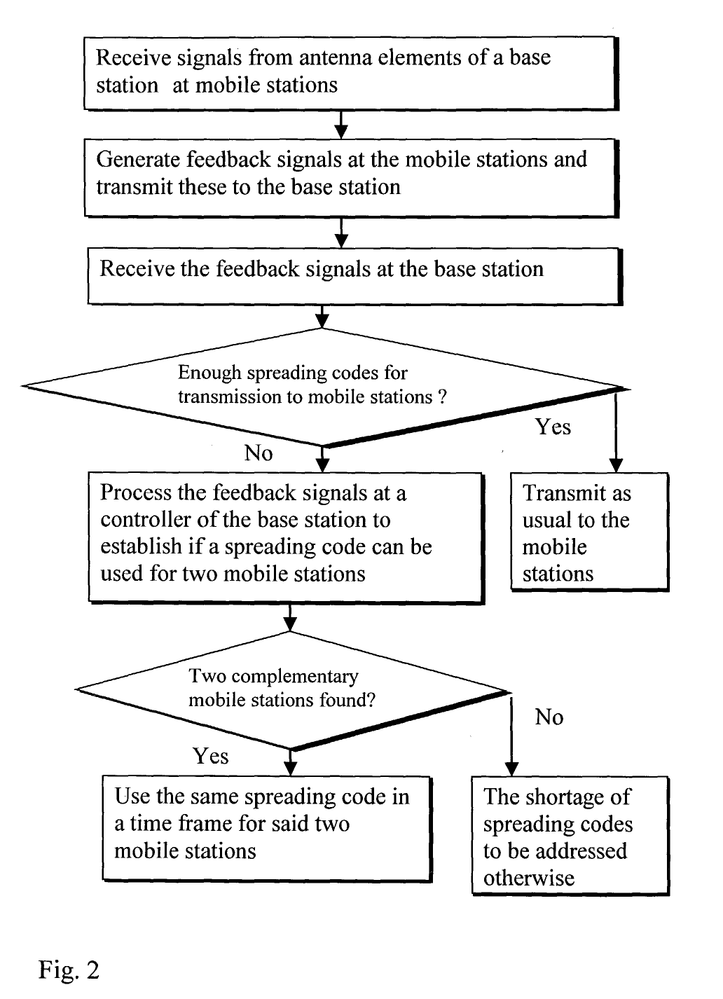

A special algorithm may be used for determining the possibility for using shared resources if a predefined condition is met. The algorithm is preferably applicable to existing specifications and/or standards. The algorithm is also preferably such that it requires minor hardware changes to the existing systems. Thus the solution can be made compatible with e.g. the present WCDMA/HSDPA standards. A possible algorithm will be described below with reference to the flowchart of FIG. 2.

Lets assume that a base station is transmitting by means of its transmitter elements to a plurality of mobile stations MS1, MS2, . . . , MSn. The transmissions are received in the plurality of mobile stations listening to the base station. The mobile station then generate feedback and send the feedback to the base station. The purpose of the feedback from a particular mobile station is to give instructions to the base station regarding the manner how any further communication to said mobile station shall be transmitted.

Should the base station controller determine that a shortage of spreading codes separating the users in the downlink is likely to occur (or that the spreading codes have already run out), the base station controller may study the feedback from the mobile stations MS1, . . . , MSn in order to try to search for at least one pair of mobile stations for which the feedback is complementary. More detailed examples of when this condition is met will be given below.

If the base station finds that two such mobile stations, say MS1 and MS2, exist, the base station may insert information to these two stations into the same time interval i.e. time frame. That is, the base station may transmit to mobile stations MS1 and MS2 at the same time and use the same spreading codes for the two mobile stations MS1 and MS2.

The inventors have found this type of operation is possible is access methods where time multiplexed transmission is used between the stations. An example of such access methods is the High Speed Downlink Packet Access (HSDPA).

It shall be appreciated that this type of operations does not need to be a mandatory feature of the base station. That is, the scheduling can used only if there is a risk of running out of channelisation codes or the codes have already run out. In other circumstances the system will be operated without sharing the spreading codes.

In the below explained more detailed embodiment it is assumed that a signal is transmitted to the mobile station by means of a closed loop (CL) method. The closed loop method can be either the so called mode 1 or mode 2 closed loop. To facilitate the understanding of the embodiment, the difference between these two closed loop modes is briefly explained first.

Channels corresponding to first and second base station transmit antennae can be described by channel impulse responses h1 and h2 which are complex vectors. In two-antenna closed-loop modes transmitter sets complex weights w1 and w2 such that received signal to noise ratio (SNR) in a mobile station is maximized, i.e. w1 and w2 are selected such that

∥ŵ₁h₁+ŵ₂h₂∥²=max{∥w₁h₁+w₂h₂∥²:w₁,w₂εW}

Hence the closed-loop (CL) transmit diversity signals from two transmit antennas can be adjusted such that they sum up coherently. This adjustment can be done by the base station controller based on the feedback signals.

In the FDD WCDMA closed-loop mode 1 the quantization set W consists of two points. The base station may obtain transmit weights by interpolating between two consecutive feedback messages.

In the FDD WCDMA mode 2 the quantization W consists of 16 points corresponding to 8 phasing alternatives and two amplitude weight alternatives. Hence, the length of the feedback word is four bits in mode 2.

Those interested may find a mode detailed explanation of the closed loop modes as well as a detailed explanation of the FDD WCDMA from Third Generation Partnership Project Technical Specification 3GPP TS 25.214 version 4.2.0 (September 2001) titled Technical Specification Group Radio Access network; Physical Layer Procedures (FDD). This document is incorporated herein by reference. An explanation of the FDD WCDMA closed loop can also be found from an article by two of the Inventors J. Hämäläinen, R. Wichman: “Closed-Loop Transmit Diversity for FDD WCDMA Systems”, Asilomar conference on signals systems and computers, 2001. This document is also incorporated herein by reference.

In a simple case the base station controller may test if the request on the feedback signals are complimentary. This can be illustrated such that if

(w1,w2)=(1,1) for MS1 and (u1,u2)=(1,−1) for MS2 then their feedback is complementary since

(w1,w2)*(u1,u2)=w1*u1+w2*u2=1−1=0,

i.e. the inner product between feedback words is zero.

The interpolation between consecutive 1-bit feedback words in closed-loop (CL) mode 1 leads to adjustment of the Quadrature Phase Shift Keying (QPSK). In this approach phase adjustment is selected in accordance with feedback from a mobile station from the set of four alternatives. An example of the alternatives is given in the table below:

TABLE 1
An example of the possible alternative feedback bits

| Consecutive | Phase |
|---|---|
| Feedback bits | Adjustment |
| 00 | 0 |
| 01 | π/2 |
| 11 | π |
| 10 | −π/2 |

The spreading and scrambling codes can then be set to be the same for both mobile stations. Then, in a single path channel, the mobile stations MS1 and MS2 would receive

MS1: r₁=(w_{1,1}h_{1,1}+w_{2,1}h_{2,1})s₁+(w_{1,2}h_{1,1}+w_{2,2}h_{2,1})s₂+n₁

MS2: r₂=(w_{1,1}h_{1,2}+w_{2,1}h_{2,2})s₁+(w_{1,2}h_{1,2}+w_{2,2}h_{2,2})s₂+n₂

where h_{k,l} is the impulse response of the channel between k th antenna and l th mobile station user, w_{k,l} is the transmit weight on k th antenna requested by l th mobile user, s1 is the symbol for user 1, s2 is the symbol for mobile user MS2 and n1, n2 are the noise terms.

The condition set for the scheduling of the mobile stations MS1 and MS2 may be such that they can employ the same spreading code if

(w_{1,1},w_{2,1})*(w_{1,2}, w_{2,2})=0

That is, the mobile stations can employ the same spreading code if they have requested orthogonal feedback from the base station.

As a result the desired powers for the first and second mobile stations can be maximized. In terms of signal to noise ration (SNR) this can be expressed as

γ_{1,1}=E{|w_{1,1}h_{1,1}+w_{2,1}h_{2,1}|²}=max{E{|w₁h_{1,1}+w₂h_{2,1}|²}:|w₁|²+|w₂|²=1}

γ_{2,2}=E{|w_{1,2}h_{1,2}+w_{2,2}h_{2,2}|²}=max{E{|w₁h_{1,2}+w₂h_{2,2}|²}:|w₁|²+|w₂|²=1}

The undesired power for the first and second mobile stations may also be minimized. In terms of SNR this can be expressed as

γ_{1,2}=E{|w_{1,2}h_{1,1}+w_{2,2}h_{2,1}|²}=min{E{|w₁h_{1,1}+w₂h_{2,1}|²}:|w₁|²+w₂|²=1}

γ_{2,1}=E{|w_{1,1}h_{1,2}+w_{2,1}h_{2,2}|²}=min{E{|w₁h_{1,2}+w₂h_{2,2}|²}:|w₁|²+|w₂|²=1}

The adjusted channels corresponding to separate mobile stations MS1 and MS2 are uncorrelated:

E{(w_{1,1}h_{1,1}+w_{2,1}h_{2,1})*(w_{1,2}h_{1,1}+w_{2,2}h_{2,1})}=(w_{1,1})*w_{1,2}E{|h_{1,1}|²}+(w_{2,1})*w_{2,2}E {|h_{2,1}|²}=0

E{(w_{1,1}h_{1,2}+w_{2,1}h_{2,2})*(w_{1,2}h_{1,2}+w_{2,2}h_{2,2})}=(w_{1,1})*w_{1,2}E{|h_{1,2}|²}+(w_{2,1})*w_{2,2}E{|h_{2,2}|²}=0

As can be seen, any cross terms have vanished from the above. This is so since the antennae of the base station are uncorrelated. The last equality results from the orthogonal transmit weights of the antennae and expected equal reception powers from separate antennae of the base station.

The above-mentioned benefits are believed to reflect directly into the performance. This can be studied by computing the ratio of the SNR's between the desired and undesired signals in mode 1 and mode 2, respectively. The computations are discussed in more detail in the above referenced article by the Inventors J. Hämäläinen, R. Wichman: “Closed-Loop Transmit Diversity for FDD WCDMA Systems”, Asilomar conference on signals systems and computers, 2001. Assuming that transmit power is normalized between the antennae we get

$$\begin{matrix}R = \frac{{γ}_{1 , 1}}{{γ}_{1 , 2}} = \frac{{γ}_{2 , 2}}{{γ}_{2 , 1}} = \frac{1 + π / 4 {c}_{N}}{1 - π / 4 {c}_{N}} = \frac{1 + 1 / \sqrt{2}}{1 - 1 / \sqrt{2}} = 7.65 dB & ( mode 1 ) \\ and \\ R = \frac{{γ}_{1 , 1}}{{γ}_{1 , 2}} = \frac{{γ}_{2 , 2}}{{γ}_{2 , 1}} = 13.5 dB & ( mode 2 )\end{matrix}$$

These relatively large ratios are explained by the fact that channel adjustments strengthens the desired signals for both users while they also weaken the undesired signals for both users.

The above discussed method can also be used also when two scrambling codes are employed. The users may be scheduled such that (Mode 1) users having feedback 00 are using scrambling code 1 and users having feedback 11 are served using scrambling code 2. At time t users having feedback 11 or 00 are served while at time instant t+1 users having feedback 10 or 01 are served. Other scheduling schemes are also possible. Scheduling based on both power and transmit diversity feedback can also be used. Hence it is possible to set thresholds and transmit only if the instant ratio R (measured in mobile) is high for both mobile stations employing the same spreading code. Alternatively, it is possible to transmit only to those mobile station users for which the ratio is high.

The above described embodiments propose a scheduling scheme for code multiplexing in a time frame wherein the mobile stations can be assigned the same channelization codes if the transmit weights are orthogonal. Using the herein proposed method, code reuse is possible with a marginal loss in performance. The solution improves the code efficiency of e.g. a HSDPA based systems and potentially therefore the cell capacity compared to traditional closed-loop solutions. The embodiments may provide a way to improve cell capacity for multi-antenna sites using the HSDPA, especially for environments where code shortage may be expected to occur.

It should be appreciated that whilst embodiments of the present invention have been described in relation to mobile stations, embodiments of the present invention are applicable to any other suitable type of user equipment.

In addition to the code resources, the orthogonal resources may comprise resources such as time resources and/or frequency resources.

Furthermore, although the above describes embodiments wherein two user equipment share the orthogonal resources, this is not necessarily the upper limit for the number of user equipment. Although the complementary property described above may only be fulfilled by two user equipment, this property can be further extended e.g. by means of using more than two transmitting elements (e.g. two antennae) in the base station.

Furthermore, FIG. 1 shows only one base station. The invention may also be applied to situations wherein user equipment listen to transmitting elements of more than one base station, e.g. during a handover from a base station to another.

The information is described as being packet data. In alternative embodiments of the invention the information to be included in a time frame be may be in any suitable format.

The embodiment of the present invention has been described in the context of a 3G WCDMA (Wideband Code Division Multiple Access) UMTS (Universal Mobile Telecommunications System). The proposed solution can be used in other systems providing communications between mobile stations and base stations. For example, the embodiment may be applicable to system such as AMPS (American Mobile Phone System), DAMPS (Digital AMPS), i-phone, CDMA 2000, and so on. In addition to PLMN systems, the embodiments may be applicable to other wireless communication systems such as wireless local area networks (W-LAN) and mobile communication systems that are at least partially based on use of communication satellites. In addition to code division multiple access, the invention is also applicable to other access techniques such as orthogonal frequency division multiple access (OFMDA), time division multiple access or space division multiple access as well as any hybrids thereof.

It is also noted herein that while the above describes exemplifying embodiments of the invention, there are several variations and modifications which may be made to the disclosed solution without departing from the scope of the present invention as defined in the appended claims.

1. A method in a communication system arranged to provide communication channels for transmission of information to user equipment in time frames such that information to a plurality user equipment can be multiplexed into a time frame, the method comprising:
receiving signals from transmitting elements of the communication system in at least two user equipment;
processing the received signals at said at least two user equipment to generate respective feedback signals;
receiving the feedback signals at a controller associated with the transmitting elements of the communication system; and
processing the feedback signals at the controller for determining how to multiplex information into time frames in further transmissions to said at least two user equipment, wherein the determination is based on the feedback signals and a resource allocation scheme that allows use of same resource for transmissions to the at least two user equipment if a predefined condition is met.

2. The method as claimed in claim 1, wherein the resource comprises a spreading code of a code division multiple access system.

3. The method as claimed in claim 2, wherein the code division multiple access system comprises a wideband code division multiple access system.

4. The method as claimed in claim 3, comprising transmission of information by means of frequency division duplexing.

5. The method as claimed in claim 3, comprising transmission of information by means of high speed downlink packet access.

6. The method as claimed in claim 2, wherein the code division multiple access system comprises a code division multiple access 2000 (CDMA 2000) system.

7. The method as claimed in claim 1, comprising transmission of information by means of orthogonal frequency division multiple access, wherein the resource that can be shared by the at least two user equipment comprises a subfrequency.

8. The method as claimed in claim 1, wherein the condition is met when feedback signals from two mobile stations are complimentary.

9. The method as claimed in claim 1, comprising adjusting antenna weights of the transmitting elements so that the predefined condition can be met.

10. The method as claimed in claim 1, comprising sending the feedback in accordance with wideband code division multiple access frequency division duplex (WCDMA FDD) mode 1.

11. The method as claimed in claim 1, comprising sending the feedback in accordance with wideband code division multiple access frequency division duplex (WCDMA FDD) mode 2.

12. A communication system comprising:
a plurality of user equipment, each user equipment comprising a transceiver and a processor,
transmitting elements arranged to provide communication channels for transmission of information to the plurality of user equipment in time frames such that information can be multiplexed into a time frame, and
a controller associated with the transmitting elements, wherein the processor of each user equipment is arranged to process signals received by the transceiver from the transmitting elements to generate a feedback signal, and the feedback signals is processed at the controller for determining how to multiplex information into time frames in further transmissions to user equipment based on the feedback signals and a resource allocation scheme that allows use of same resource for transmissions to at least two user equipment if a predefined condition is met, and the transmitting elements are arranged to use said same resource in a time frame for transmission to the at least two user equipment if so decided by the controller.

13. The communication system as claimed in claim 1, wherein the resource comprises a spreading code of a code division multiple access (CDMA) system.

14. The communication system as claimed in claim 13, wherein the code division multiple access system comprises a wideband code division multiple access system.

15. The communication system as claimed in claim 14, the system being arranged to employ frequency division duplexing (FDD).

16. The communication system as claimed in claim 14, comprising transmission of information by means of high speed downlink packet access.

17. The communication system as claimed in claim 13, wherein the code division multiple access system comprises a code division multiple access 2000 (CDMA 2000) system.

18. The communication system as claimed in claim 12 arranged to employ orthogonal frequency division multiple access for transmission of information, wherein the sharable resource comprises a subfrequency.

19. A controller for use in association with transmitting elements of a communication system, the transmitting elements being arranged to provide communication channels for transmission of information to a plurality of user equipment in time frames such that information can be multiplexed into a time frame, wherein the controller is arranged to process feedback signals from the user equipment for determining how to multiplex information into time frames in further transmissions to user equipment based on the feedback signals and a resource allocation scheme that allows use of same resource for transmissions to at least two user equipment if a predefined condition is met, and to control the transmitting elements to use said same resource in a time frame for transmission to the at least two user equipment.
